(19) United States
(12) Patent Application Publication
(10) Pub. No.: US 2016/0090518 A1
(43) Pub. Date: Mar. 31, 2016

(54) WATER-COOLED EXTRUDER IMPROVEMENTS

(71) Applicant: Chemagineering Corporation, Rolling Meadows, IL (US)

(72) Inventor: Peter E. Greenlimb, Inverness, IL (US)

(21) Appl. No.: 14/502,436

(22) Filed: Sep. 30, 2014

(51) Int. Cl. C09K 5/04

(52) U.S. Cl. CPC C09K 5/04

(57) ABSTRACT

Water-cooled extrusion equipment capable of operating at high temperatures in forming chemical and plastic components is highly subject to water-influenced corrosion of, and/or deposition of water-borne dissolved solids on, the narrow conduits carrying the circulating coolant and the system components and auxiliaries in contact with the coolant. The inventive water-based coolant circulated through the extrusion equipment's cooling passages is purified, thus having a reduced amount of dissolved solids and incorporates: (1) a yellow metal inhibitor for preventing corrosion and fouling of non-ferrous metals forming the coolant-bearing passages; (2) an organic/inorganic alkaline nitrogen-based compound to raise the pH of the water and reduce corrosion; and (3) a reducing agent to passivate the equipment's steel surfaces to reduce metal loss. The use of the inventive coolant increases reliability and operating lifetime of the extrusion equipment, while reducing equipment downtime and associated costs without modification to existing systems.

### FIELD OF THE INVENTION

This invention relates generally to water-cooled extrusion equipment, and is particularly directed to an improved composition of the water used for cooling the extrusion equipment which reduces corrosion of, and the deposition of scale on, the water passages and system components and auxiliaries of the extrusion equipment to increase equipment reliability and prolong its operating lifetime, without changing the design or the composition of the equipment.

### BACKGROUND OF THE INVENTION

During the operation of water-cooled extrusion equipment, severe system corrosion, mineral scale deposition and fouling can and often does occur in the cooling water passages. Various contributing factors to these potential operation interrupting conditions include, but are not limited to, high surface and bulk water temperatures, narrow water passages, the coupling/connection of components comprised of dissimilar metals, the use of high purity, unbuffered corrosive waters having wide variations in water quality, and the common demands of extended, continuous use of the extruder systems. Manufacturers of water-cooled extruders generally advise those who purchase their equipment to use distilled, deionized or demineralized quality water “properly treated” to prevent water-influenced corrosion and/or deposition of water-borne dissolved solids. However, no one in the extruder manufacturing industry has defined “properly treated” water, nor has anyone provided much in the way of assistance in controlling extrusion system corrosion and scale problems. While the use of high purity water as the cooling medium reduces scale deposition, the aggressive nature of this type of water at elevated operating temperatures and the large variations in water purity contribute to premature component corrosion and failure.

Ideally, once optimum zone temperatures are achieved in extrusion equipment, the extrusion process should proceed adiabatically, i.e., at constant entropy, or without gain or loss of heat. However, the extrusion process typically involves frequent cycles of heat input and heat dissipation in order to maintain optimum extrusion melt zone temperatures. Heat input is typically delivered electrically through embedded heating elements in the extrusion barrel zone heater/cooler. Cooling is commonly achieved by the introduction of cooling water into small diameter coils also embedded in the barrel zone castings. At extrusion melt zone temperatures in excess of 200° F., cooling is not achieved by means of a conventional water/heat transfer mechanism, but rather though the evaporation of a small quantity of water that is introduced into the heater/cooler in a regulated manner from an inlet manifold. Because virtually all of the cooling is achieved by evaporation in the zone heater/cooler, the properties and characteristics of the cooling water are of utmost importance.

Extruder barrel cooling systems are typically comprised of various metals which provide viable sites for galvanic corrosion mechanisms. For example, newer extruder systems can contain corrosion-resistant metals such as nickel alloys, copper, brass, stainless and mild steels, cast iron pump housings, and zinc sacrificial anodes located in water reservoir tanks. Frequently when critical components fail, less corrosion-resistant replacement parts are used in order to minimize downtime and expense. Unfortunately, the less noble nature of these replacement parts gives rise to corrosion and increased rates of failure, resulting in severe fouling of cooling water passages, premature part failures, and more frequent unscheduled and costly outages. These high temperature, water-cooled extrusion systems are designed for twenty-four (24) hours a day, seven (7) days a week operation, which is typically how many of these systems are employed. Thus, downtime is difficult to make up for. In addition, multiple cooling zones are typically required, each responsible for maintaining temperatures in a particular section of the extrusion equipment. Failure of one zone requires terminating extruder operation.

Various waters and coolants can present operational problems when used in extruder cooling water systems. Distilled, demineralized, deionized and other unbuffered high purity waters often contribute to the corrosion and subsequent failure of extruder system components. Softened water poses the greatest threat due to its enhanced ability to conduct galvanic corrosion currents and its inherent propensity to initiate and promote corrosion. Untreated or conventionally treated raw waters will almost always lead to unwanted mineral and/or chemical deposit accumulations in the cooling passages of extruder zone heaters/coolers. In addition, corrosion under these deposits frequently occurs as a consequence of this type of deposition. Under-deposit corrosion is difficult to detect and eliminate. Organic fluids and glycols have also been utilized as extruder coolants, but they are less thermally efficient than water in terms of their heat capacity and can be readily oxidized into corrosive and acidic organic acids, which further accelerates the corrosion of system components.

The present invention addresses these considerations and problems encountered in prior art water cooling systems for use in high temperature extrusion equipment by providing an improved water-based coolant for this type of equipment which reduces corrosion and scaling, thus increasing reliability and prolonging operating lifetime of this type of equipment.

### OBJECTS AND SUMMARY OF THE INVENTION

Accordingly, it is an object of the present invention to reduce unscheduled outages and prolong the operating lifetime of water-cooled extrusion equipment by reducing surface and component corrosion of the cooling water-carrying passageways within the extrusion equipment.

It is another object of the present invention to increase the performance of water-cooled extrusion equipment by raising the pH of the circulating water to an alkaline level using an organic or inorganic alkaline nitrogen-based compound.

It is another object of the present invention to passivate all metallic surfaces and components in contact with the recirculating cooling water by reducing the corrosivity of the circulating water.

A yet further object of the present invention is to reduce the extent of galvanic corrosion mechanisms arising from the use of dissimilar metals in the cooling-water carrying conduits of high operating temperature extruder systems.

The present invention contemplates a coolant solution particularly adapted for controlling the temperature of extrusion machines capable of forming plastic, rubber and other common materials into components having a wide range of shapes and configurations and adapted for manufacturing a very large variety of items used by individuals and businesses throughout industry. The coolant is comprised of purified water having less than five (5) parts per million of total dissolved solids. The water may be purified by virtually any common water purification process. The coolant also includes a yellow metal corrosion inhibitor for inhibiting corrosion of non-ferrous metals, such as copper, brass and similar metals and their alloys. The cooling solution further includes an alkaline nitrogen-based material for neutralizing the aggressiveness of the extruder cooling waters toward the water-bearing surfaces of the extrusion barrel cooling system, as well as a reducing agent for passivating metal surfaces in direct contact with the solution.

### BRIEF DESCRIPTION OF THE DRAWINGS

The appended claims set forth those novel features which characterize the invention. However, the invention itself, as well as further objects and advantages thereof will best be understood by reference of the following detailed description of a preferred embodiment taken in conjunction with the accompanying drawings, where like reference characters identify like elements throughout the various figures, in which:

FIG. 1 is a schematic drawing of a portion of a typical water-cooled extruder zone arrangement coupled to a conventional cooling water circulating system in which the coolant of the present invention is adapted for use in controlling the operating temperature of the extruder arrangement;

FIG. 2 is an inner side view of one-half portion of a heater/cooler in the extruder arrangement in which a coolant is circulated for controlling the operating temperature of the extruder arrangement; and

FIG. 3 is an inner side elevation view of the upper and lower quarter portions of the one-half portion of the heater/cooler shown in FIG. 2 illustrating the spaced coolant-bearing conduits within the heater/cooler.

### DETAILED DESCRIPTION OF THE PREFERRED EMBODIMENTS

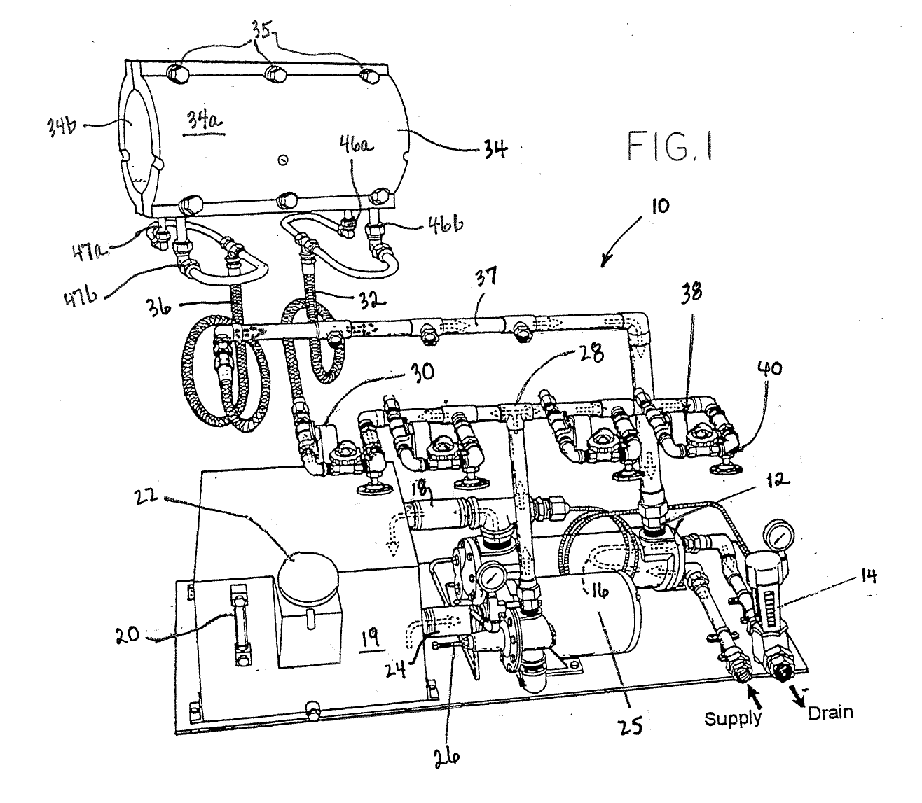

Referring to FIG. 1, there is shown a schematic diagram of a zone water heating/cooling system 10 for use with a conventional extruder system in which the inventive coolant is intended for use. Water heating/cooling system 10 is adapted to receive water from a conventional water supply. The incoming water is provided to a heat exchanger 12. Also provided to heat exchanger 12 is the coolant of the present invention which is circulated in the heater/cooler portion 34 of the extruder system. Heat exchanger 12 includes a coil 16 shown in dotted line form. In heat exchanger 12, water from the water supply is used to control the temperature of the coolant circulated through a heater/cooler 34 which forms a portion of a conventional high temperature extrusion system, with the remaining portions of the extrusion system not shown for simplicity. The water provided from the supply to the heat exchanger 12 is discharged to a drain via a regulating valve 14 for controlling the temperature of the water provided to the water/cooling system 10. In the water heating/cooling system 10 is a water tank 19 containing the coolant of the present invention. Tank 19 includes a sight gauge 20 and a pressure cap 22. Sight gauge 20 permits a visual determination of the water level in water tank 19, while pressure cap 22 allows for the release of excess pressure from the water tank. The water flows from tank 19 via a water outlet coupling 24 to pump 25 and thence to the zone inlet manifold 28. A bypass 26 is coupled in the water line adjacent the input to pump 25 to regulate the amount of coolant provided by pump 16 to the inlet manifold 28. Inlet manifold 28 is in the general form of a “T”, with one branch providing coolant to a zone solenoid 30, and a second branch providing coolant to the combination of a flow indicator 38 and a throttling valve 40, which is optional. Zone solenoid 30 is coupled by means of an inlet conduit 32 and a first pair of couplings 46a and 46b to heater/cooler 34. First coupling 46a connected to a first outlet end of the inlet conduit 32 provides coolant to one half of the heater/cooler 34, while second coupling 46b connected to the inlet conduit provides coolant to the other half of the heater/cooler. The coolant provided from the inlet conduit 32 to the heater/cooler 34 regulates the temperature of the heater/cooler for controlling the temperature of a particular zone, or portion, of the extrusion system. Heater/cooler 34 is typically comprised of a first half section 34a and a second half section 34b connected together in a sealed manner.

Coolant circulated through the heater/cooler 34 is discharged from the heater/cooler via a second pair of outlet connectors 47a and 47b each coupled to a respective half of the heater/cooler, with the discharged coolant provided via an outlet conduit 36 coupled to the second pair of outlet connectors to a first end of a return manifold 37. The second opposed end of the return manifold 37 is coupled to the heat exchanger 12 which provides the coolant to water tank 19 for circulating the coolant within the water heating/cooling system 10.

The water heating/cooling system 10 is representative of an extruder heating/cooling system illustrating one zone, or portion, of the complete extruder cooling system. The precise temperatures required for each of the zones of the extruder system requires one water heating/cooling system 10 as shown in FIG. 1 for precisely controlling the water temperature provided to the associated zones of the extruder system. Heat exchanger 12 is used to cool the water provided to the heater/cooler 34 as needed in controlling the temperature of an associated portion of the extruder arrangement. When cooling is called for by a zone temperature sensor (not shown), the zone solenoid valve 30 opens and allows coolant into the heater/cooler 34. Pump 25 draws the coolant from the water tank 19 and delivers it (regulated to about 30 psi) to the inlet manifold 28 and then via zone solenoid 30 to the heater/cooler 34. When the temperature of an extrusion zone is set above the boiling point of water, i.e., 212° F. (100° C.), the coolant will flash to steam upon entering the heater/cooler 34. Incoloy and other alloyed steel cooling tubes (described below) cast within the heater/cooler 34 carry the cooled water through the heater/cooler 34 to regulate the zone temperature. The heated water and/or flashed steam then flows out of the heater/cooler 34 and into the return manifold 37 for delivery to the shell side of the heat exchanger 12. Plant water from the supply flows through the tube side of the heat exchanger 12, which is depicted as a U-shaped tube 16 (shown in dotted line from), for cooling the distilled coolant flowing through the heat exchanger's shell side. The plant water supply flow is modulated by the regulating valve 14 to maintain the distilled coolant sump tank 19 at a temperature typically between 120° F. and 180° F. (49° C. and 82° C.).

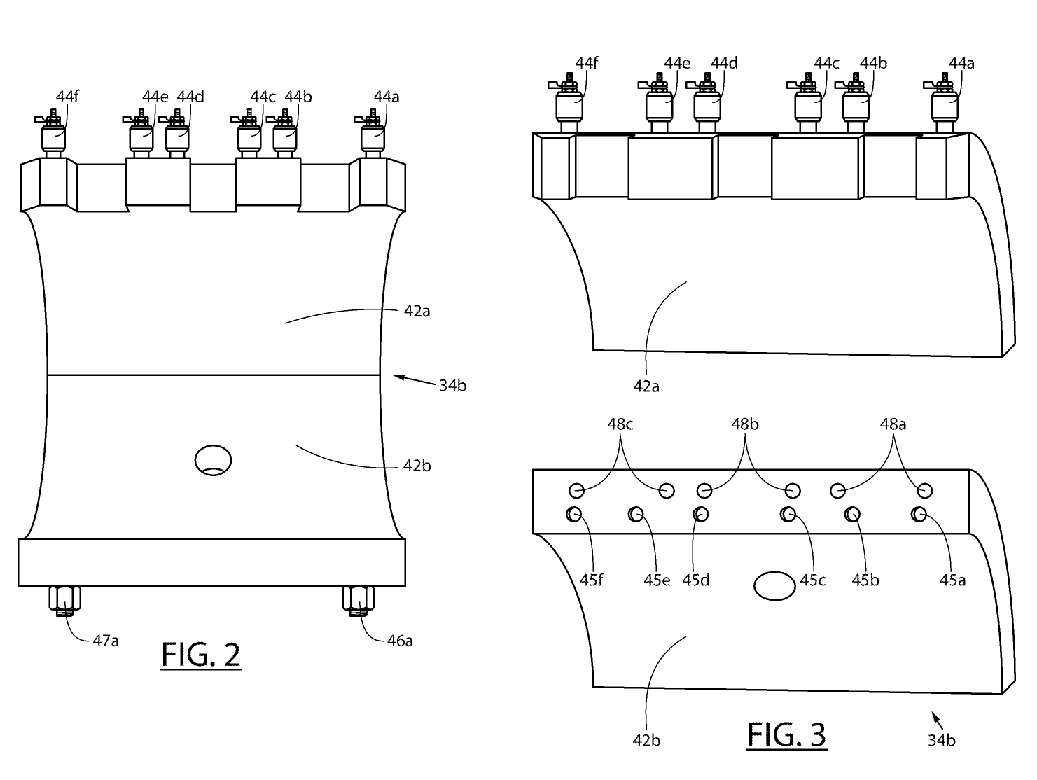

Referring to FIG. 2, there is shown an inner portion of the second half section 34b of the heater/cooler 34 shown in FIG. 1. Each of the heater/cooler's half sections 34a and 34b includes an upper portion and a lower portion, where the upper and lower portions of the heater/cooler's second half section 34b are shown as upper and lower quarter sections 42a and 42b in FIG. 2. Upper and lower quarter sections 42a, 42b were originally cast as one half of a heater/cooler pair similar to 34b. In actual operation both half sections 34a and 34b are securely coupled together in a sealed manner by conventional means (not shown) to carry the coolant provided to the heater/cooler 34. Connected to the lower quarter section 42b are the coolant inlet connector 46a and the coolant outlet connector 47a also shown in FIG. 1. Connected to upper quarter section 42a of the heater/cooler's second half section 34b are plural spaced electrical connectors 44a-44f. Referring also to FIG. 3, each pair of adjacent upper electrical connectors 44a-44f is coupled to a respective one of electrical leads 48a-48c which each extend through a pair of adjacent slots extending through the connected upper and lower quarter sections 42a and 42b. For example, the first electrical lead 48a is coupled at a first end to the first electrical connector 44a, extends through the pair of electrical lead slots on the right, as viewed in FIG. 3, and is connected at its second opposed end to the second electrical connector 44b. The first electrical lead 48a thus extends through the coupled upper and lower heater/cooler quarter sections 42a and 42b in a serpentine manner. Second and third electrical leads 48b and 48c are similarly coupled to a second pair of electrical connectors 44c and 44d and to a third pair of electrical connectors 44e and 44f, respectively, and extend through the upper and lower quarter sections 42a, 42b in a serpentine manner. Each heater/cooler zone pair 34a and 34b has one set of water connectors, inlet connector 46a and outlet connector 47a, connected in a sealed, continuous serpentine manner within the half section, with one water connector being a coolant inlet connector 46a and the other serving as a coolant outlet connector 47a for circulating coolant through the heater/cooler 34. It is on the inner surface of each of the heater/cooler's half sections as well as in the internal water conduits 45a-45f extending through the heater/cooler 34 where corrosion and scale buildup occurs because of the extreme environment to which the heater/cooler is exposed as described above. The present invention addresses corrosion and scale buildup within the heater/cooler 34 and associated system components and auxiliaries by introducing a coolant having a unique composition which reduces corrosion and scale buildup within the heater/cooler as described in the following paragraphs.

The unique coolant composition of the present invention employs high purity water having very low dissolved solids and minerals such as produced by distillation, deionization, demineralization and/or microfiltration. The high purity water of the present invention preferably contains less than two parts per million, and in no case more than five parts per million, of total dissolved solids, such as of calcium, magnesium, sodium, bicarbonate, chloride, sulfate, nitrate and silica. These types of impurities tend to come out of solution and form an insulating barrier on the serpentine internal water conduits 45 within heater/cooler 34. To form corrosion on these surfaces, there must be some way, or means, within the coolant to conduct corrosion cell electric currents. Dissolved salts, such as those of chloride, increase the electrical conductance of the water-based coolant giving rise to corrosive products of most metal alloys, even those of stainless, nickel and chrome steels.

The second component of the inventive cooling water is a yellow metal inhibitor for controlling corrosion. By “yellow” is meant non-ferrous metals, such as copper, brass and alloys of these and similar metals. The preferred corrosion inhibitor is tolyltriazole, while alternative corrosion inhibitors include benzotriazole and mercaptobenzothiazole. The present invention also contemplates the use of the three aforementioned corrosion inhibitors either individually or in combination with one or both of the remaining corrosion inhibitors.

The third component of the coolant of the present invention for use with extrusion systems is an alkaline nitrogen-based material or compound. The alkaline nitrogen-based material may be either organic or inorganic in composition and functions to elevate the pH of the water and neutralize its acidity. Neutralizing the water's acidity passivates the water-bearing surfaces of the heater/cooler and renders these surfaces less reactive to the water's inherent corrosiveness. An example of an organic alkaline nitrogen-based material for use in the present invention is morpholine [O(CH₂CH₂)₂NH]. An organic alkaline nitrogen-based material having a longer carbon chain such as octadecylamine [CH₃(CH₂)₁₇NH₂] can also be utilized. These types of organic passivating agents are sometimes described as being “filming” agents meaning that they form a film on the surface of the metal which protects the metal surface from corrosion. Inorganic alkaline nitrogen-based materials capable of performing a similar passivating function on metal surfaces include various ammonia derivatives, but not necessarily ammonia itself which would attack the surfaces of metals such as copper or brass. In the absence of copper and copper-bearing alloys ammonia could be used with stainless steel for protecting the surface of the stainless steel as a neutralizing agent.

The fourth component of the inventive coolant for use with an extrusion arrangement is a reducing agent for passivating the metallic surfaces of all components and auxiliaries in contact with the cooling water circulated through the heater/cooler and associated equipment. An example of an organic metal passivating agent is diethylhydroxylamine [(CH₃CH₂)₂NOH] in accordance with one embodiment of the present invention. An example of an inorganic metal passivating agent is hydrazine in accordance with another embodiment of the present invention.

While particular embodiments of the present invention have been shown and described, it will be obvious to those skilled in the art that changes and modifications may be made without departing from the invention in its broader aspects. Therefore, the aim in the appended claims is to cover all such changes and modifications that fall within the true spirit and scope of the invention. The matter set forth in the foregoing description and accompanying drawings is offered by way of illustration only and not as a limitation. The actual scope of the invention is intended to be defined in the claims when viewed in their proper prospective based on the prior art.

What is claimed is:

1. A water-based coolant for use in cooling water-cooled extrusion systems comprising:
water purified by distillation, deionization, demineralization and/or microfiltration, and having less than five (5) parts per million of total dissolved solids;
a yellow metal corrosion inhibitor for inhibiting corrosion of non-ferrous metals, such as copper and brass, and similar metals and their alloys;
an alkaline nitrogen-based material for passivating coolant-bearing surfaces, metallic system components and auxiliaries associated with a water-cooled extrusion system by raising the pH of the water rendering said coolant-bearing surfaces less reactive to the water's inherent acidity;
a reducing agent for passivating metallic surfaces in direct contact with the coolant.

2. The coolant of claim 1, wherein said purified water has less than two (2) parts per million of total dissolved solids.

3. The coolant of claim 1, wherein said yellow metal corrosion inhibitor comprises tolyltriazole, benzotriazole or mercaptobenzothiazole, or a combination thereof.

4. The coolant of claim 1, wherein said alkaline nitrogen-based material is organic.

5. The coolant of claim 4, wherein said organic alkaline nitrogen-based material is morpholine [O(CH₂CH₂)₂NH], or an organic alkaline nitrogen-based material having a longer carbon chain.

6. The coolant of claim 4, wherein said coolant forms a film on a surface on the coolant bearing surfaces.

7. The coolant of claim 1, wherein said alkaline nitrogen-based material is inorganic.

8. The coolant of claim 7, wherein said inorganic alkaline nitrogen-based material is ammonia or an ammonia derivative.

9. The coolant of claim 1, wherein said alkaline nitrogen-based material neutralizes the acidity of the water.

10. The coolant of claim 1, wherein said reducing agent is diethylhydroxylamine [(CH₃CH₂)₂NOH].

11. The coolant of claim 1, wherein said reducing agent is hydrazine.
